(19) United States
(12) Patent Application Publication
(10) Pub. No.: US 2007/0278248 A1
(43) Pub. Date: Dec. 6, 2007

(54) Self-contained remote fueling system

(76) Inventor: Scott M. Van Vliet, Edmonton (CA)

Correspondence Address: PEDERSEN & COMPANY, PLLC, P.O. BOX 2666, BOISE, ID, 83701, US

(21) Appl. No.: 11/444,602

(22) Filed: May 31, 2006

(51) Int. Cl. B67D 5/64

(52) U.S. Cl. 222/133

(57) ABSTRACT

A remote refueling station including a storage tank for storing fluids, a pumping station for transferring fluids from the storage tank, a lighting system, an environmentally protected enclosure, and an onboard power source located within the environmentally protected enclosure and connected to the pumping station and lighting system.

### BACKGROUND

Automated remote refueling systems are used for delivery of fuel to remote locations that do not have utility services. These systems allow customers to refuel machinery in a convenient and cost-efficient manner. However, some of these remote refueling systems have deficiencies.

### SUMMARY

There is provided a remote refueling station that provides rapid set up at remote locations. The remote refueling station in one embodiment comprises a storage tank for storing fluids, a pumping station for transferring fluids from the storage tank, a lighting system, an environmentally protected enclosure and an onboard power source located within the environmentally protected enclosure and connected to the pumping station and lighting system. The environmentally protected enclosure may comprise an integrally formed extension of the storage tank. The onboard power source may comprise a generator and a battery. The pumping station may comprise a card reader that reads information on a payment card, and the environmentally protected enclosure comprises a communications system that communicates payment information to a remote server.

These and other aspects of the remote refueling station are set out in the claims, which are incorporated here by reference.

### BRIEF DESCRIPTION OF THE FIGURES

Preferred embodiments of the remote refueling station will now be described with reference to the figures, in which like reference characters denote like elements, by way of example, and in which:

FIG. 1 is a perspective view of an embodiment of a remote refueling system.

FIG. 2 is a schematic diagram of the refueling system.

FIG. 3 is a schematic diagram of the communication system of the refueling system.

### DETAILED DESCRIPTION

In the claims, the word “comprising” is used in its inclusive sense and does not exclude other elements being present. The indefinite article “a” before a claim feature does not exclude more than one of the feature being present.

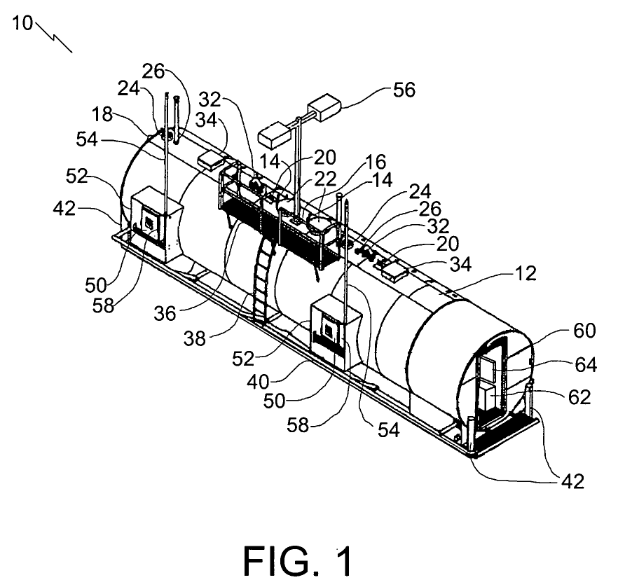

Referring to FIG. 1, a remote refueling station 10 is shown that includes a storage tank 12 for storing fluids. The storage tank 12 may be used to store any fluid required at a remote location. In one embodiment, the remote fueling station 10 provides combustibles, such as diesel or gasoline to machinery being operated in remote locations. The storage tank 12 may be any conventional tank, with modifications that will be apparent from the description within this patent document. Some of the common features that may be present include a primary and secondary water draw off and dipping port 14 and 16 respectively, a sump vent 18, horizontal lift lugs 20, a grounding lug (not shown), a manway 22, emergency vents 24, half couplers with vents 26, remote top fill 32, submersible pump enclosure 34, and a catwalk 36 with ladder 38. The tank 12 is mounted on a skid 40 or other ground engaging support structure to make the unit transportable as a single unit for remote set up, and includes bollards 42 on each corner. The tank 12 may be a partitioned tank such that different fluids may be stored in the same tank.

To transfer fluids from the storage tank, there are pumping stations 50 integrally formed with the tank 12, with a cabinet 52 to partially protect the stations 50 from the environment. In the embodiment depicted, two pumping stations 50 are provided on each side of the tank 12. Each pumping station 50 includes a high hose retriever 54 and a short hose retriever 58, which allows users to refuel at different heights if required. The area around the tank 12 is lit by a lighting system 56.

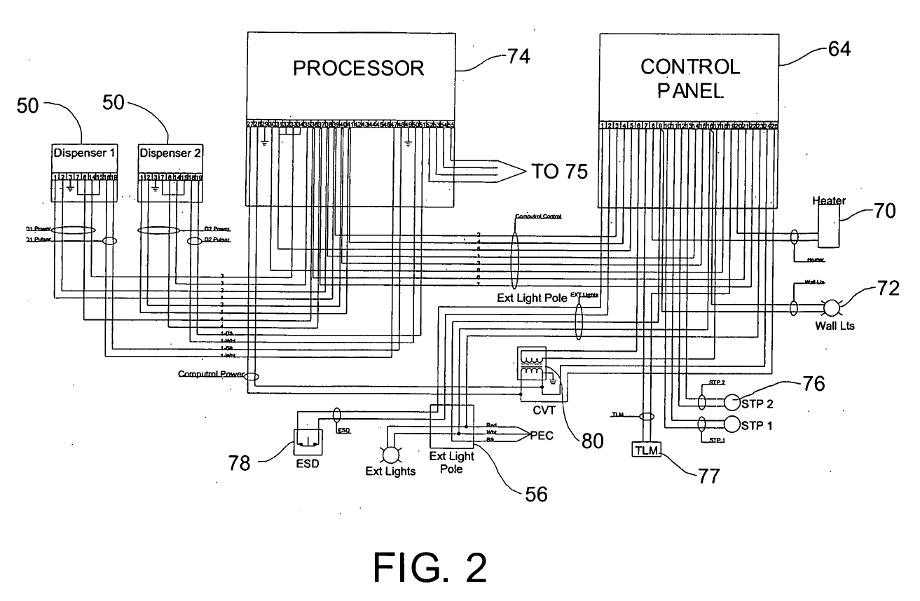

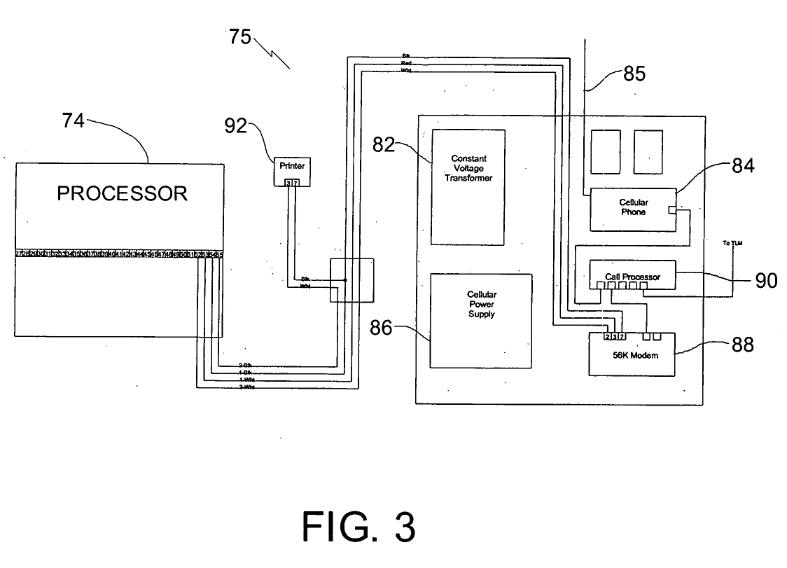

An environmentally protected enclosure 60 is located at one end of the tank 12, and is formed as an extension of the tank 12. This enclosure 60 is used to house an onboard power source 62 and control panel 64. The power source 62 is connected to provide power to the pumping stations 50 and lighting system 56 through control panel 64. The power source 62 may be any conventional power source, such as a combustion engine, and may include batteries, such that the engine charges the batteries when needed. The control panel 64 is used to control the various components, as will be discussed with reference to FIGS. 2 and 3. The power source 62 may be fueled by fuel within the tank 12. Using an onboard power source eliminates time taken in setting up a separate power source on site at a remote location. No plug-ins are required, since the combustion engine or other power source is connected prior to delivery to a remote site through the control panel 64 to deliver power for the onboard electronics.

Referring to FIG. 2, the control panel 64 is connected to a heater 70 to heat the enclosure 60 to maintain a minimum temperature, wall lights 72 within the enclosure 60 and the exterior lighting system 56, and a processor 74 that powers and controls other devices, such as the communication system 75 shown in FIG. 3, and the pumping stations 50. Other devices connected to control panel 64 include submersible pumps 76, a tank level monitor 77, an emergency shut down switch 78, and a constant voltage transformer 80.

Referring to FIG. 3, the communications system 75 is shown to include a constant voltage transformer 82, a wireless communications device such as a cellular phone 84 with an antenna 85 and power source 86, a modem 88, and a call processor 90. The communications system 75 and processor 74 process transactions as is common in the art. An example of how a transaction may proceed will now be given. When a payment card is swiped by a customer at a card reader (not shown) at one of the pumping stations 50, the processor 74 transmits this information to the modem 88, which initiates a call via call processor 90 and cellular phone 84 to transmit and receive relevant transaction information. If this is done at the beginning of the refueling process, once approval of the transaction is received by modem 88, the processor 74 allows pumping station 50 to transfer fluid from the tank 12. The final purchase amount is then applied against the balance of the payment card by modem 88. Once the transaction is completed, a printer 92 then prints a receipt for the customer.

Immaterial modifications may be made to the embodiments of the remote refueling station described here without departing from what is claimed.

What is claimed is:

1. A remote refueling station comprising:
a ground engaging support structure;
a storage tank for storing fluids, the storage tank being mounted on the ground engaging support structure;
a pumping station mounted on the ground engaging support structure for transferring fluids from the storage tank;
a lighting system mounted on the ground engaging support structure;
an environmentally protected enclosure mounted on the ground engaging support structure; and
an onboard power source and control board located within the environmentally protected enclosure and connected to supply power to the pumping station and lighting system.

2. The remote refueling station of claim 1 wherein the environmentally protected enclosure comprises an extension of the storage tank.

3. The remote refueling station of claim 2, wherein the onboard power source comprises a generator and a battery.

4. The remote fueling station of claim 3, wherein the pumping station comprises a card reader that reads information on a payment card, and the environmentally protected enclosure comprises a communications system that communicates payment information to a remote server.
